(19) United States
(12) Patent Application Publication
(10) Pub. No.: US 2014/0205987 A1
(43) Pub. Date: Jul. 24, 2014

(54) APPARATUS AND METHOD FOR ENHANCING ACADEMIC PLANNING AND TRACKING VIA AN INTERACTIVE REPOSITORY DATABASE

(71) Applicants: STEVE HABERMEHL, Roseville, CA (US); Scott Souza, Rocklin, CA (US)

(72) Inventors: STEVE HABERMEHL, Roseville, CA (US); Scott Souza, Rocklin, CA (US)

(21) Appl. No.: 13/745,717

(22) Filed: Jan. 18, 2013

(51) Int. Cl. G09B 7/00

(52) U.S. Cl. CPC G09B 7/00
USPC 434/350

(57) ABSTRACT

An apparatus and method to collect, integrate, and marshal the academic course offerings and requirements of secondary educational institutions, the admission requirements and preferences of postsecondary educational institutions, and the academic and career goals of current and prospective secondary students to assist and facilitate the creation of academic plans in a collaborative informed manner. The apparatus collects relevant information from various informed parties and makes such information available in an integrated and marshaled form enabling efficient and effective planning. The system can be adapted to assist in the academic planning of postsecondary students in light of the admissions requirements and preferences of graduate and postgraduate programs as well.

### REFERENCE TO RELATED APPLICATION

This non-provisional application corresponds to and claims the benefit of the filing date of provisional patent application No. 61/596,776 filed on Feb. 9, 2012.

### FIELD OF THE PRESENT DISCLOSURE

This disclosure relates generally to academic planning, counseling, and guidance, and more particularly to an apparatus and method of collecting, integrating, tracking, and marshaling information regarding a secondary student's completed and prospective course work with graduation requirements for a secondary educational institution and admissions criteria for selected postsecondary educational institutions, such that the students, parents, and faculty can quickly and efficiently plan and track an academic course of action tailored to a student's academic and career goals in an informed and collaborative manner.

### BACKGROUND OF THE RELATED ART

In a traditional secondary educational institution (typically grades 9 through 12), students are allowed to specialize their coursework according to their personal interests and future academic and career aspirations by choosing among a variety of electives and/or academic programs. Many secondary education curriculums allow students some degree of choice between courses within general subject matters (e.g., math, science, and/or foreign languages, etc. . . . ) but require the completion of a set number of courses within each general subject matter for graduation to ensure that each student receives a balanced education. A list of the courses offered, the subject matter category in which each course belongs, and the criteria which must be met by each student to graduate are often published in a course catalog or in graduation instructions provided by the secondary educational institution. Parents and/or students must obtain these materials, review them, and integrate them with a student's current academic progress and future academic and career goals to create an academic plan for graduation.

When creating an academic plan, parents and/or students must not only be cognizant of the graduation requirements of the secondary educational institution in which the student is currently enrolled, but must also be aware of the academic entrance requirements and preferences of any postsecondary academic programs that the student aspires to attend. These entrance requirements may range from academic prerequisites that are set forth and explained in admissions instructions and/or course catalogs to course work that may not be required but may be looked upon favorably by admissions departments when reviewing applications and deciding which of several competitive candidates to select. These requirements and preferences are also likely to differ within the same postsecondary institution depending on the field of study the student wishes to pursue. To become aware of such information, parents and/or students should both review any admissions information materials published by the various postsecondary educational institutions to which the student is interested in matriculating and also consider contacting the various admissions departments directly to solicit the opinions and recommendations of the faculty and staff.

Unfortunately for many students, much of this information is not readily available while they are planning their secondary education course work. It is uncommon for even the most engaged parents and/or students to proactively contact postsecondary educational institutions at any time prior to being eligible to apply, at which point it is often too late to significantly alter a student's secondary academic plan. To compound this problem, most postsecondary educational institutions have no efficient means of becoming familiar with a prospective student's academic performance and/or the curriculum choices offered by his or her particular secondary educational institution; therefore, even if parents and/or students have the foresight to solicit the advice of the faculty or staff of a prospective postsecondary educational institution, they must first provide a significant amount of personal and/or academic background information to the postsecondary educational institution's faculty or staff before a constructive and collaborative dialog can occur.

In short, there exists no efficient means of sharing the information necessary to effectively collaborate between parents and/or students who are in the early years of their secondary education and the faculty and staff of prospective postsecondary educational institutions. As a result, many students suffer the disadvantage of planning their secondary education without access to important and valuable information regarding the course work that would best prepare them for the challenges of their desired postsecondary educational institution and/or curriculum.

Often times, secondary educational institutions employ faculty or staff members (e.g., counselors, teachers, administrators, or vice-principals) whose responsibilities include providing academic guidance and counseling regarding the secondary educational institution's course offerings and academic graduation requirements. These faculty or staff members can assist parents and/or students make choices that complement the student's future academic and career aspirations. In fact, these faculty or staff members are typically the greatest resource for parents and students alike.

However, it is not uncommon for these faculty or staff members to be responsible for hundreds, if not thousands, of students; therefore, the faculty or staff members have very little time to review any one particular student's current academic progress, much less the student's personal academic and career goals. Consequently, faculty or staff members charged with this duty often provide generalized or standardized counseling and advice. There exists a need to organize and marshal the presentation of individualized information regarding students' personal and academic career performance and goals so that a faculty or staff member can quickly and efficiently learn or be reminded of personal information relevant to each student.

Further, even the most dedicated and experienced faculty or staff members may have difficulty staying abreast of the requirements and preferences of the several different postsecondary educational institutions to which students may wish to matriculate. A secondary educational institution's faculty or staff member may contact multiple postsecondary educational institutions and discuss admissions requirements and preferences, but this process is time consuming and may be impractical depending on the number of students and institutions involved. There exists a need to automate the collection, organization, and presentation of this information so that it may be quickly and efficiently referenced by all interested parties.

Similar challenges exist for postsecondary students who aspire to matriculate to graduate and/or postgraduate educational institutions or programs. There exists a need for a system to collect and marshal relevant information regarding admissions requirements and preferences of graduate and/or postgraduate programs so that parents and/or students can more effectively create a postsecondary academic plan at an early stage in a student's academic career to prepare for the requirements and challenges of graduate and postgraduate educational institutions and programs.

The present disclosure distinguishes over the related art providing heretofore unknown advantages as described in the following summary.

### BRIEF SUMMARY OF THE INVENTION

The present disclosure relates to an apparatus and method of efficiently and conveniently collecting, tracking, and marshaling information regarding the academic entrance requirements of postsecondary academic programs in which a secondary student has expressed interested in attending with his or her completed and prospective secondary course work such that parents, students, and faculty of both the secondary and postsecondary educational institutions may quickly and efficiently collaborate to create an academic plan that best assists a student achieve his or her goals in a timely and informed manner.

The disclosure describes a system that encompasses an apparatus and method, the apparatus comprises either firmware or a programmable computer that is programmed with, and capable of executing, software or some combination thereof. The system directs a method of collection and organization of relevant academic parameters and information and stores such information in a repository database. The system is capable of bidirectional communication through secure portals allowing various relevant parties, including parents, student, and faculty or staff members of relevant educational institutions, varying levels of access to the information needed to make collaborative and informed choices. Security provisions may control access to sensitive information such as the student's personal information and academic records. In an exemplary embodiment, relevant parties may communicate with the apparatus using personal computers or terminals in communication with the presently disclosed system via Internet protocol or compatible peripheral hardware.

The system may begin by prompting the collection of the relevant background information from educational institutions and other relevant parties. For example, when the system is initiated by a faculty member of a secondary educational institution, the system may request information relevant to the institution such as the various courses that the secondary educational institution offers, the hours of credit assigned to each offered course, and the course credit criteria that must be met by each student to be eligible to graduate. This information is then stored in a repository database that may be accessed to guide and direct parents and/or students when creating an academic plan and/or reviewing a created plan for compliance with the secondary educational institution's graduation criteria.

Faculty or staff of postsecondary, graduate, or postgraduate educational institutions may contribute their various institution's respective academic admissions requirements and preferences as well. The system may accept and store this relevant information for each institution and/or for each field of study within each institution in the repository database. When a parent and/or student indicates that the student is potentially interested in attending a particular postsecondary, graduate, or postgraduate educational institution or is interested in pursuing a specific field of study, the system may retrieve information specific to the parent and/or students selection and present such information for review and consideration while the parents and/or student are creating an academic plan.

The system may also compare the resulting academic plan created by the parents and/or student for congruence with the admissions requirements and preferences of the selected educational institutions or fields of study. When incongruence is determined the system may communicate such determination and allow the parents and/or student to amend the academic plan.

Depending on the particular embodiment, parents and/or students may be able to securely log into a portal to the system via a personal computer or terminal capable of communicating through Internet protocol or using compatible peripheral hardware. The manner in which information is communicated to and from the system is not intended to be limited by this disclosure. Communication should be bidirectional with numerous relevant parties.

The parents and/or student may begin by entering data or selecting among prompted options provided by the system to input the student's personal information. In some embodiments, the system may begin by requesting that the parents and/or student identify the particular secondary institution that the student attends or plans to attend. Once identified, the system will guide access the academic curriculum options, parameters, and relevant information provided by the faculty or staff of the identified secondary educational institutions stored in the repository database and assist parents and/or student to create an academic plan.

In some embodiments, one such prompt may request parents and/or students to select one or more postsecondary educational institutions and/or fields of study that the student is interested in pursuing. Upon receiving a response to this prompt, the system will access information relevant to the response stored in the system's repository database and make such information available to parents and/or students. Through this system, parents and/or students will learn of the requirements and preferences of the various selected postsecondary educational institutions at a very early stage in the student's education. This marshaled information may then be utilized by parents and/or students to make informed decisions when creating an academic plan for a student's secondary education.

After an academic plan is completed, the system may review the academic plan for compliance with both the graduation requirements of the secondary educational institution in which the student is enrolled and the admissions requirements and preferences of the selected postsecondary educational institutions. If the academic plan does not meet all the requirements and preferences of the various institutions, the system may bring the inconsistencies to the attention of the parents and/or students and allow parents and/or student an opportunity to amend the academic plan, should they choose to do so.

Once the parents and/or student are satisfied with the academic plan, the system may notify a faculty or staff member of the secondary educational institution that an academic plan has been created and is ready for review and approval. The faculty or staff member may then log into the system via the secondary educational institution's portal and quickly and efficiently review the proposed academic plan and relevant personal information regarding the student's past academic performance and future personal, academic, and career goals including the postsecondary education institutions to which the student aspires to matriculate. The faculty or staff member may then approve the plan if he or she finds it satisfactory. In some embodiments, the faculty or staff member may then make comments or recommendations, suggest changes to the academic plan, and/or request a meeting with parents and/or the student.

The faculty or staff member may ask questions, make comments, or otherwise communicate through the system or by alternative means. In some embodiments such correspondence may be stored in the repository database and may be available for reference by select parties at a future date.

Once a the faculty or staff member approves an academic plan, the system may, in some embodiments, directly export the approved academic plan to the educational institution's class scheduling system and reserve the student's position in the various classes the plan indicates. Scheduling confirmation or conflicts may be communicated back through the system allowing parents and/or student to make alternative plans at an early juncture.

The system may also be utilized by students who are currently enrolled in postsecondary educational institutions who are interested in matriculating to graduate or postgraduate educational institutions or programs. The system may collect and present admissions requirements and preferences of the selected graduate and postgraduate educational institutions or programs, assist students in creating an academic plan by presenting recommended course work, communicate proposed academic plans to the faculty or staff of the students' secondary and/or graduate educational institutions, and in some embodiments, communicate approved plans to the student's current educational institutions' scheduling systems.

This disclosure teaches certain benefits in construction and use which give rise to the objectives described below.

A primary objective inherent in the above-described apparatus and method is to collect, integrate, track, and marshal information regarding a student's current and past academic progress, the academic graduation requirements of a student's secondary educational institution, and the admissions requirements and preferences of a student's desired postsecondary educational institutions so as to enhance the ability of parents and/or students to efficiently create a collaborative and informed plan to achieve the student's academic and career goals.

Another objective is to provide an apparatus and method to collect, integrate, track, and marshal information regarding a student's current academic progress, the graduation requirements of a student's secondary educational institution, and the admissions requirements and preferences of a student's desired postsecondary educational institutions to assist faculty or staff of secondary educational institutions charged with the duty of academically guiding and counseling students to quickly and efficiently become familiar with a student's current academic progress and future academic and career goals in order to provide informed and effective guidance and counsel to that student.

A further objective is to provide an apparatus and method to assist faculty or staff of secondary educational institutions to review, comment, amend, and/or approve academic plans created by parents and/or students in an efficient and collaborative manner.

A still further objective is to provide an apparatus and method to import a collaboratively created and approved academic plan into the scheduling system of an academic institution.

A still further objective is to provide an apparatus and method to collect, integrate, track, and marshal information regarding a student's current academic progress, the graduation requirements of a student's secondary educational institution, and the admissions requirements and preferences of a student's desired postsecondary educational institutions to assist faculty or staff of postsecondary educational institutions in informing the faculty and staff of secondary educational institutions of relevant admission requirements and preferences of the postsecondary educational institutions so that faculty and staff of secondary educational institution may provide more informed and effective guidance and counsel to students at an earlier point in a student's academic career.

A still further objective is to provide an apparatus and method to collect, integrate, track, and marshal information regarding a student's current academic progress, the graduation requirements of a student's secondary educational institution, and the admission's requirements and preferences of a student's desired postsecondary educational institutions to assist faculty or staff of postsecondary educational institutions in informing parents and/or students of admissions requirements and preferences while the student is still early in his or her secondary education so that parents and/or students may plan more effectively.

A still further objective is to provide an apparatus and method to collect, integrate, track, and marshal information regarding a student's current academic progress, the graduation requirements of a student's current postsecondary or graduate educational institution, and the admissions requirements and preferences of a student's desired graduate or post-graduate educational institutions or programs to assist parents, students, and the faculty or staff of the student's current postsecondary or graduate educational institution to plan and counsel in a more informed and collaborative manner.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE DRAWING(S)

The accompanying drawings are diagrams that illustrate various exemplary implementations and are part of the specification. The illustrated implementations are proffered for purposes of example, not for purposes of limitation. Illustrated elements and steps will be designated by numbers. Once designated, an element or step will be identified by the identical number throughout. Illustrated in the accompanying diagram drawings is at least one of the best mode embodiments of the present disclosure. In such drawings:

FIG. 1 is a schematic of an exemplary embodiment of the presently disclosed system;

FIG. 2 is a block diagram of an exemplary embodiment of the presently disclosed apparatus and method featuring the collection, integration, tracking, and marshaling of information regarding a secondary educational institution;

FIG. 3 is a flow chart of an exemplary embodiment of the presently disclosed method featuring various steps including the integration of a counselor's judgment;

FIG. 4 is a block diagram of an exemplary embodiment of the presently disclosed apparatus and method featuring the various categories of information that maybe reviewed by the faculty or staff of a secondary educational institution;

FIG. 5 is a block diagram of an exemplary embodiment of the presently disclosed apparatus and method featuring the various categories of information that maybe reviewed by parents and/or students.

### DETAILED DESCRIPTION OF THE EXEMPLARY EMBODIMENT

The above described drawings illustrate an exemplary embodiment of an apparatus and method of use in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example, and that it should not be taken as a limitation in the scope of the present apparatus and method of use.

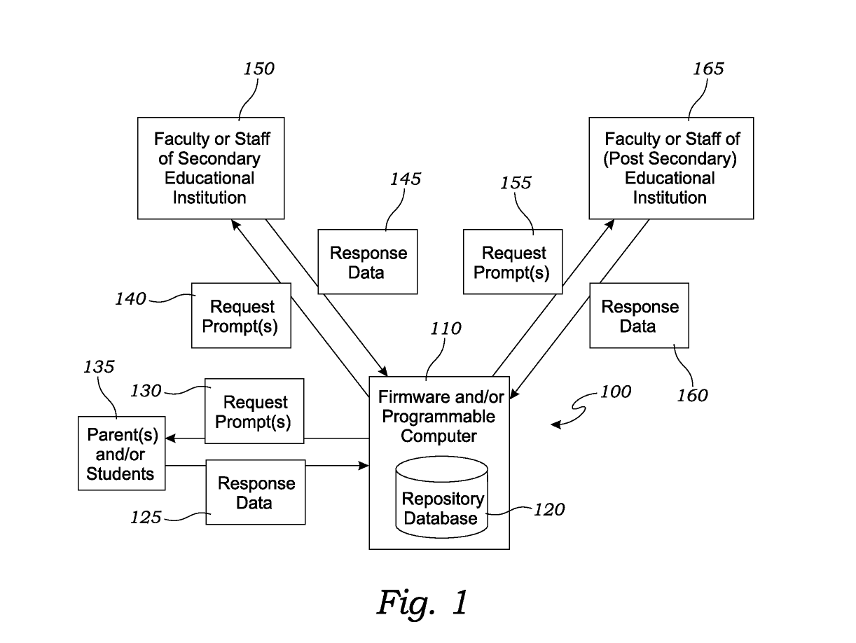

Described now in detail is an apparatus and method of collecting, integrating, tracking, and marshaling information regarding a secondary student's completed and prospective course work with graduation requirements for the secondary educational institution and admissions criteria for selected postsecondary educational institutions such that the students, parents, and educators, including faculty or staff of both secondary and postsecondary educational institutions, can quickly and efficiently strategize and track an academic plan tailored to a student's academic and career goals in an informed and collaborative manner. FIG. 1 is a schematic illustrating an exemplary embodiment of the presently disclosed system 100. The system 100 comprises firmware or a programmable computer 110 programmed with and capable of executing software or some combination thereof that directs and executes the presently described method. The system 100 is capable of both receiving and transmitting data and control signals through interactive portals and features a repository database 120 for storing relevant input and boundary conditions. In some embodiments, the system 100 is capable of receiving and transmitting data and control signals via Internet protocol. In other embodiments the apparatus is capable of receiving and transmitting data and control signals via compatible peripheral hardware. Embodiments incorporating both Internet protocol as well as peripheral hardware are also possible.

FIG. 1 also graphically illustrates bidirectional communication though interactive portals with exemplary interested parties such as faculty or staff of secondary educational institutions 150, faculty or staff of postsecondary institutions 165, and parents and/or students 135. These parties are intended to be representative of the various exemplary interested parties that may have relevant information that may be collected and shared to collaboratively plan a secondary student's academic course work. The parties mentioned are not intended to be limiting. The system 100 may be adapted to prompt and accept input from the faculty or staff of postsecondary, graduate, postgraduate educational institutions or programs to assist a student collected and utilized valuable information relevant to assisting parents and/or students effectively create academic plans at any point in the student's academic career.

In some embodiments the method may begin by collecting various academic parameters, requirements, and boundary conditions related to the secondary educational institution that may assist parents and/or students 135 plan a secondary student academic course work. The faculty or staff of secondary educational institutions 150 may be prompted 140 to enter various academic parameters and boundary conditions such as the courses that the institution offers, the credit value assigned to each course, and the course credit criteria required for the student to graduate. In other embodiments this information may be collected through alternate modes without the without the use of request prompt 140. In the disclosed embodiment, once prompted 140, the faculty or staff 150 may respond by inputting relevant data 145 into the database 120.

The system 100 may be utilized by a single secondary educational institution or may be shared by several institutions. When the system 100 shared by several institutions, each institution may communicate with the system 100 through a separate portal and security measures may allow access to personal and academic information regarding only students attending that particular academic institution. However, the system 100 allows less sensitive information with broader relevance such as information regarding admission requirements and preferences of postsecondary educational institutions to be shared among all participating secondary educational institutions.

FIG. 1 also depicts the bidirectional communication with the faculty or staff of postsecondary educational institutions 165. Each participating postsecondary educational institution 165 may provide academic admissions requirements and preferences by logging into a portal, identifying the postsecondary educational institution with which they are associated, and depending on the particular embodiment, proffering relevant information or responding 160 to request prompts 155 initiated by the system 100. The repository database 120 may then store the entered data 155 in the repository database 120 and make it available when parents and/or students 135 indicate an interest in matriculating to that particular postsecondary educational institution.

Some embodiments of the system 100 may prompt 155 faculty or staff of postsecondary educational institutions 165 to provide specific admissions preferences and requirements for each field of study or degree program that the postsecondary educational institution offers. Each data response 160 may then be stored in the repository database 120 and be recalled when parents and/or students express an interest in that particular degree program or field of study.

Once the institutional information has been collected and stored in the repository database 120, the system 100 may begin to assist parents and/or students 135 in creating an academic plan. The term parents is intended to expansive including the singular parent, legal guardians, caretakers and/or any individual who has a personal or advisory relationship with a student.

In some embodiments, parents and/or students 135 may log into a secure portal to be guided by a series of request prompts 130 to make choices regarding present and future course offerings and a student's future academic and career aspirations. In other embodiments, students may communicate with the system 100 from an open and unsecured student platform that assists students in selecting academic course work but does not accept and store sensitive personal information. The system 100 may then review the response data 125 and evaluate the viability of the academic plan that parents and/or students 135 created in light of the admissions requirement and preferences of the selected postsecondary educational institutions and/or the selected degree programs or fields of study. If the academic plan created by parents and/or students 135 is inconsistent with the admissions requirements and preferences of the selected postsecondary educational institutions and/or the selected degree programs or fields of study, the system 100 may, in some embodiments, notify parents and/or students 135 of such inconsistencies and allow the opportunity to amend the academic plan.

After parents and/or students 135 are satisfied with the academic plan, the system 100 may submit it to the faculty or staff of the secondary educational institution 150 for review and approval. The faculty or staff 150 may suggest changes, request an in-person meeting with the parents and/or students 135, approve the academic plan, or choose some additional course of action.

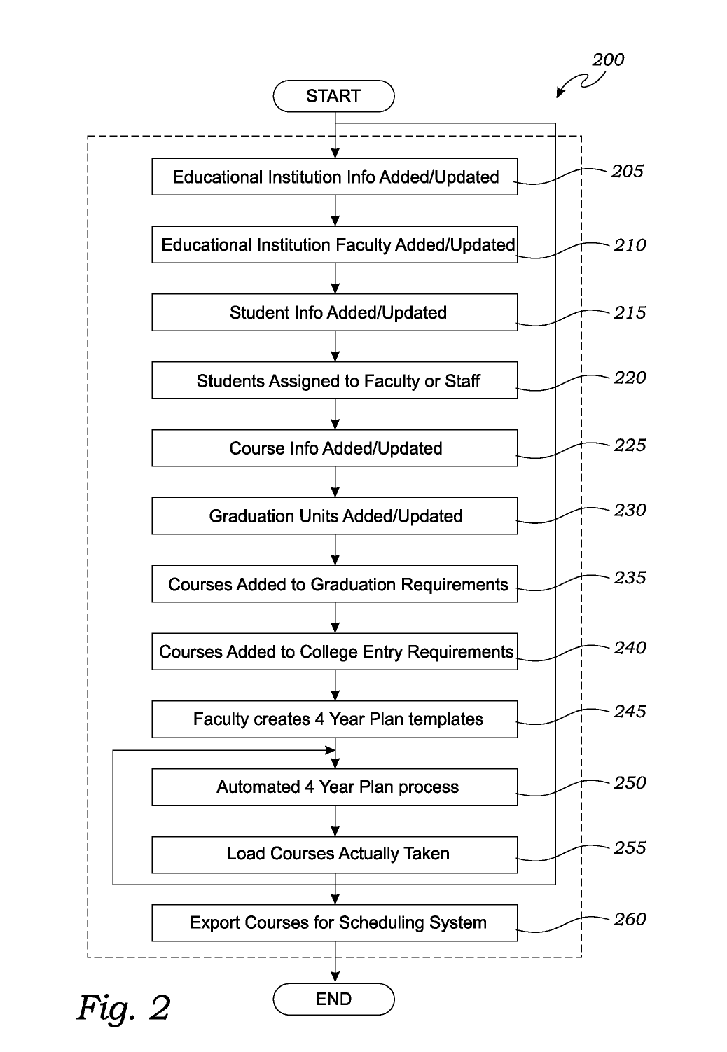

FIG. 2 illustrates a block diagram 200 of the various categories of information and criteria that may be entered into the repository database 120 before the system 100 can assist parents and/or students 135. In no particular order the list may include: information regarding the particular secondary educational institution 205; information regarding the institution's faculty or staff 210; personal information regarding the secondary student 215; information regarding which faculty or staff members are assigned to advise and/or counsel which particular secondary students 220; information regarding the variety of academic courses offered by the institution 225; information regarding the number of units required to graduate 230; information regarding recent changes in course and academic units required for graduation 235; information regarding the courses required and preferred for admission to particular postsecondary educational institutions 240; and information regarding a four-year academic plan templates created by faculty or staff of the secondary educational institution 245.

FIG. 2 illustrates that once the information has been collected the system may assist parents and/or students 135 generate an automated four-year academic plan 250, designating course work already completed by the secondary student 255, and export the four0year academic plan to the secondary institutions class scheduling system 260. The term four-year academic plan refers to the typical length of a secondary education. If the length of a secondary education is more or less than four years then the term four-year academic plan would refer to this different period of time.

In some embodiments much of the required background information regarding the secondary institution may be preloaded bypassing the series of prompts and responses designed to collect such information. This is depicted in FIG. 2 by the arrow from start position to just before the automated creation of a four-year academic plan 250.

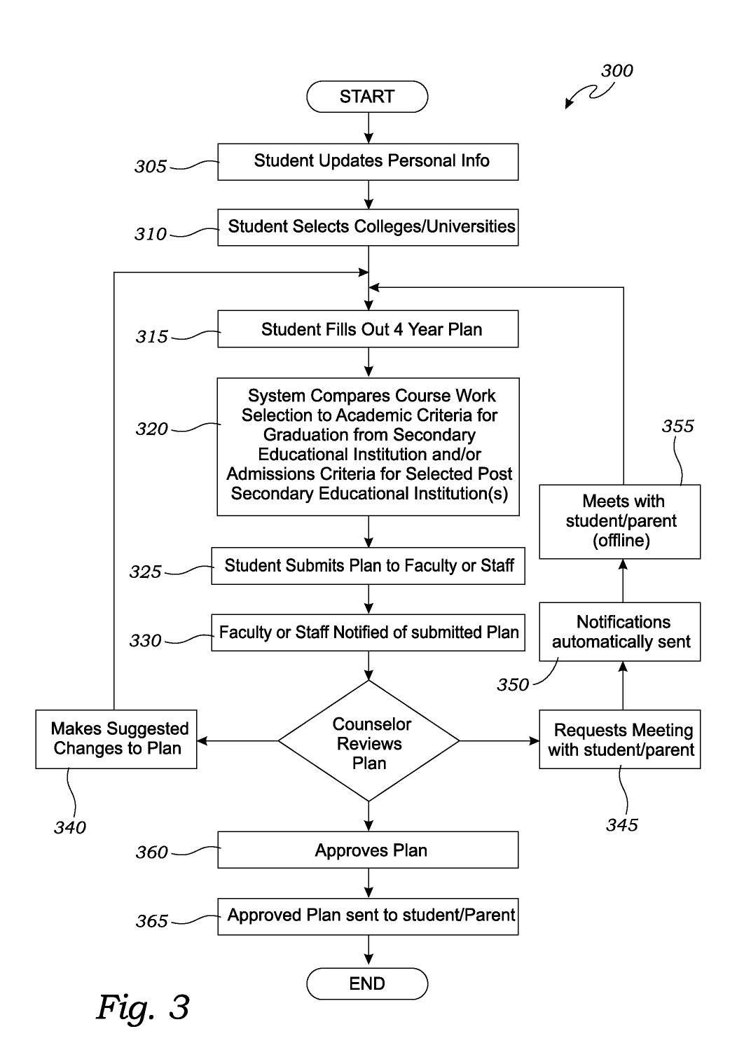

FIG. 3 is a flowchart that illustrates an exemplary method 300 executed by the presently disclosed system 100. The exemplary method 300 illustrated in FIG. 3 is not intended to be limiting but rather is an illustration of one possible embodiment of the method performed by the presently disclosed system 100. The method includes the steps of allowing parents and/or students 135 to log into a portal and provide identifying information and/or other relevant personal and academic information regarding the secondary student 305. An additional step prompts parents and/or students to indicate postsecondary, graduate, and postgraduate educational institutions and programs that the secondary student aspires to attend 310. These may include vocational or job-training institutions.

The method also allows parents and/or students 135 to make choices leading to the creation of a four-year academic plan 315 guided by the offered courses available and graduation criteria. In some embodiments, the system may interact with the secondary educational institution's scheduling systems showing class capacity and availability. Once an four-year academic plan 315 has been selected, the system 100 may check the selected four-year academic plan against the graduation requirements for the particular secondary educational institution and the admissions requirements and preferences for the selected postsecondary educational institution 320. The system may also submit the plan to the faculty or staff of the secondary educational institution for review 325. In some embodiments, the system may allow parents and/or students 135 an opportunity to amend the four-year academic plan before it is submitted to the faculty or staff of the secondary educational institution 325 if the system 100 discovers the four-year academic plan and the graduation requirements of the secondary educational institutional and/or admissions requirements and preferences of the selected postsecondary educational institutions are incongruent.

Once the academic four year plan is submitted to the faculty or staff of the secondary educational institution 135, the faculty or staff may be notified 330 and may access and review the four-year academic plan 335. The faculty or staff may choose to make suggested changes to the four-year academic plan 340, request a meeting with parents and/or students 345, or approve the plan as is 360. Notification of the faculty or staffs request to meet with parents and/or students may be sent through the system 350 and, in some embodiments, the meeting can occur on-line. In other embodiments, the meeting may occur in-person or in a manner selected by the parties.

If the faculty or staff of the secondary educational institution suggests changes 340 or requests a meeting 345, parents and/or students 135 may be allowed an additional opportunity to amend the four-year academic plan 315. The amended plan may be reviewed again by the system 320 and be resubmitted to the faculty or staff of the secondary educational institution for approval 325. Upon approval, the four year academic plan may be sent to parents and/or students 365 and may be exported to the educational institution's class scheduling system.

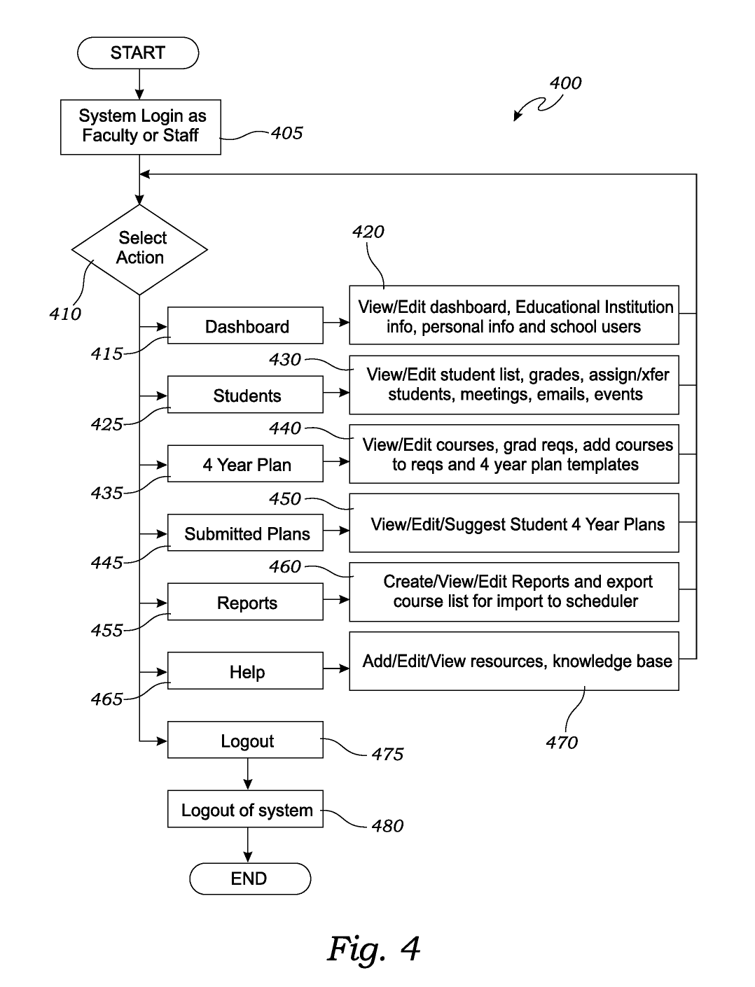

FIG. 4. is a block diagram illustrating the organization of an exemplar portal designed for the faculty or staff of a secondary educational institution 400. The portal may begin with a login step for security purposes 405. Once the identity of the faculty or staff of the secondary educational institution is confirmed, the system 100 offers the opportunity to choose the category of information to access 410. In the disclosed exemplar portal illustrated in FIG. 4, these categories include: a “dashboard” option 415, allowing viewing and editorial access to information regarding the institution, the faculty or staff employed by the institution, and those faculty or staff who have access to the system 100, 420; a “students” option 425, allowing viewing and editorial access to information regarding enrolled and transfer students, academic progress and grades, and scheduling events such as meetings and communication with students 430; a “four-year academic plans” option 435 allowing viewing and editorial access four-year academic plan templates, graduation requirements, available courses 440; a “submitted plans” option 445, allowing viewing and editorial access to previously approved four-year academic plans and student progress in regards to such plans 450; a “reports” option 455, allowing viewing and editorial access to reports regarding four-year academic plans as well as other scheduled and enrolled courses 460; and a “help” option 465, allowing to various resources such as a system map and guidance. The options illustrated in FIG. 4 are examples and are not intended to be limiting. Upon exiting, the faculty and staff may logout of the faculty or staff portal 475 and the system 480.

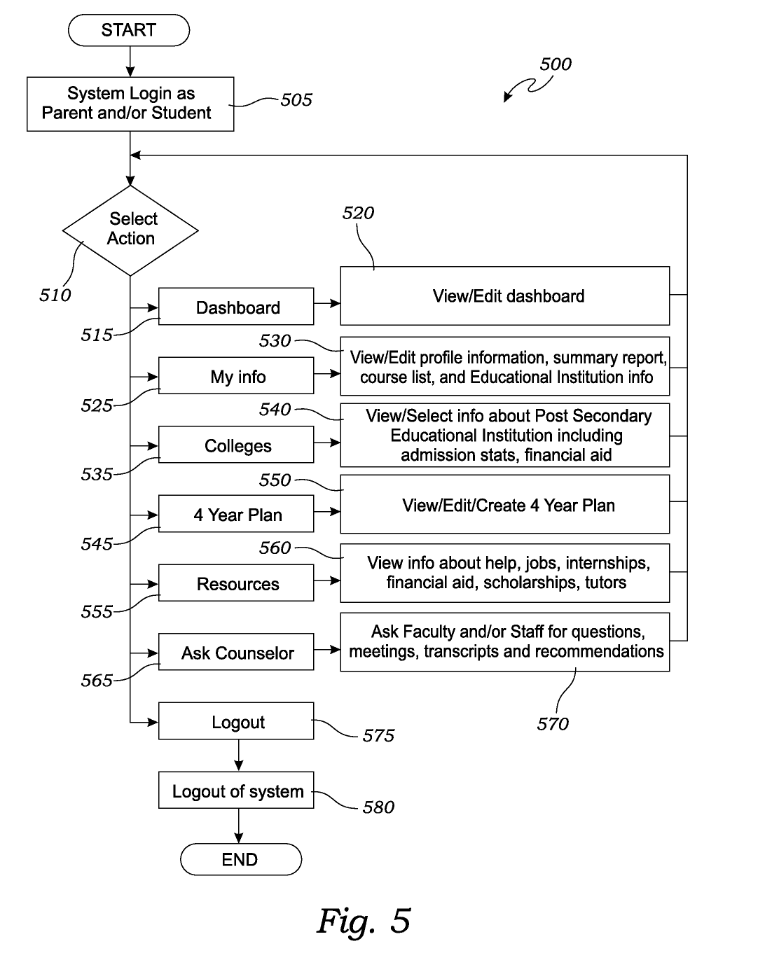

A similar portal 500 may exist for parents and/or students 135. Parents and/or students 135 may log into the system 505 and provide information or make a selection 510 among several options. In the exemplary portal 500 illustrated in FIG. 5 the parents and/or student may select among the options on a “dashboard” 515, allowing viewing and editorial access to the arrangement and available information category options 520; “my info” option 525, allowing viewing and editorial access to personal information regarding the secondary student, secondary educational institution, and secondary student's academic history 530; a postsecondary educational institutions option, allowing viewing and editorial access to selected postsecondary educational institutions including associated admissions requirements and preferences and finical aid information 540; a “four-year academic plan” option 545, allowing viewing and editorial access to the secondary students four year academic plan 550; a “resources” option 555, allowing viewing and editorial access to information regarding jobs, internships, financial aid, tutors, and scholarships 560; and a “counselor” option 565, allowing communication with the faculty or staff of the secondary educational institution to ask questions, arrange meetings, and solicit recommendations 570. As with the faculty or staff portal, the options listed in FIG. 5 are merely provided as exemplar, portals may be organized in any way that is found to be useful for the system 100 users. When parents and/or students 135 wish to leave the portal they may logout 575 of their personal portal and then logout 580 of the system 100.

The system 100 may be adapted to allow parents and/or student to create and academic plan for a postsecondary student with graduate or postgraduate educational institutions in mind. In such embodiments, rather than a four-year academic plan, the academic plan would be for the length of the students current academic program. Such embodiments may also include additional system 100 participants, options, or information relevant to assisting the parents and/or student achieve the student's personal, academic and professional goals.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventors believe that the claimed subject matter is what is intended to be patented.

What is claimed is:

1. A method for assisting parents, students, and educators to efficiently and collaboratively create and track an academic plan for a student's secondary education, including the steps of:
1) prompting educators from at least one secondary educational institution to input academic criteria pertaining to said secondary educational institution including course offerings, course credits, and credit criteria required for graduation;
2) receiving said academic criteria input from said secondary educational institutions;
3) storing said academic criteria input received from said secondary educational institution in a repository database;
4) prompting at least one student or parents of said student to create an academic plan for said student's secondary education by selecting course work from among said course offerings provided by said secondary educational institution;
5) receiving said course work selections from said student or parents of said student;
6) storing said course work selections from said student or parents of said student in said repository database;
7) comparing said course work selection and said academic criteria including said course offerings, course credits, and credit criteria required for graduation;
8) determining whether the course work selection meets said academic criteria including said course offerings, course credits, and credit criteria required for graduation;
9) notifying said student or parents of said student whether the course work selection meets said academic criteria including said course offerings, course credits, and credit criteria required for graduation;

2. The method of claim 1 further comprising the steps of:
1) exporting course work selections to said secondary education institution's scheduling system.

3. The method of claim 1 further comprising the step of:
1) receiving and storing correspondence between said parents, students, and educators; and
2) allowing correspondence between said parents, students, and educators to be subsequently accessed and reviewed by corresponding.

4. The method of claim 1 further comprising the steps of:
1) receiving amended course work selections from said student or the parents of said student to comport with academic criteria including said course offerings, course credits, and credit criteria required for graduation;
2) storing amended course work selections from said student or parents of said student in said repository database;
3) comparing said amended course work selections to said academic criteria including said course offerings, course credits, and credit criteria required for graduation;
4) determining whether said amended course work selections meets said academic criteria including said course offerings, course credits, and credit criteria required for graduation;
5) notifying said student or parents of said student whether amended course work selection meets said academic criteria including said course offerings, course credits, and credit criteria required for graduation.

5. The method of claim 1 further comprising the steps of:
1) submitting said course work selections from said student or parents of said student to an educator associated with said secondary educational institution for review and assessment;
2) receiving the review and assessment results from said educator associated with said secondary educational institution;
3) storing said review and assessment results from said educator associated with said secondary educational institution in repository database;
4) notifying said student or parents of said student of said review and assessment results from said educator associated with said secondary educational institution.

6. The method of claim 5 further comprising the steps of:
1) exporting course work selection to said secondary education institution's scheduling system upon receiving favorable review and assessment results from said educator associated with said secondary educational institution.

7. The method of claim 5 further comprising the steps of:
1) communicating said changes or suggested changes made by an educator associated with said secondary educational institution upon review and assessment of course work selection with student or parents of said student.

8. The method as in claim 5 further comprising the steps of:
1) prompting said student or parents of said student with a request for a meeting made by an educator associated with said secondary educational institution upon review and assessment of course work.

9. A method of claim 7 further comprising the steps of:
1) receiving amended course work selections from said student or parents of said student to comport changes and/or suggested changes made by an educator associated with said secondary educational institution upon review and assessment of course work selection;
2) storing amended course work selections from said student or parents of said student in said repository database;
3) comparing said amended course work selection to said academic criteria including said course offerings, course credits, and credit criteria required for graduation;
4) determining whether said amended course work selection meets said academic criteria including said course offerings, course credits, and credit criteria required for graduation;
5) notifying said student or parents of said student whether amended course work selection meets said academic criteria including said course offerings, course credits, and credit criteria required for graduation.

10. The method of claim 9 further comprising the steps of:
1) submitting said course work selections as amended from said student or parents of said student to an educator associated with said secondary educational institution for review and assessment;
2) receiving the review and assessment results from said educator associated with said secondary educational institution;
3) storing said review and assessment results from said educator associated with said secondary educational institution in repository database;
4) notifying said student or parents of said student of said review and assessment results from said educator associated with said secondary educational institution.

11. The method of claim 10 further comprising the steps of:
2) exporting said course work selection to said secondary education institution's scheduling system upon receiving favorable review and assessment results from said educator associated with said secondary educational institution.

12. The method of claim 2 further comprising the steps of:
1) prompting the educators associated with at least one postsecondary educational institutions to input academic criteria for admissions, including required and preferred secondary course work;
2) receiving academic criteria for admissions input including required and preferred secondary course work from said educators associated with said postsecondary educational institution(s);
3) storing academic criteria for admissions input including required and preferred secondary course work from said educators associated with said postsecondary educational institution(s) in the repository database;
4) prompting at least one student or parents of said student to select at least one postsecondary educational institution(s) to which said secondary student aspires to matriculate;
5) comparing said course work selection to said academic criteria for admission including required and preferred secondary course work of selected postsecondary educational institution(s);
6) determining whether said course work selection meets said academic criteria for admission to selected postsecondary educational institution(s) including required and preferred secondary course work;
7) notifying said student or parents of said student whether said course work selection meets said academic criteria for admission to selected postsecondary educational institution(s) including required and preferred secondary course work of selected postsecondary educational institution(s).

13. The method of claim 12 further comprising the steps of:
1) receiving amended course work selections from said student or parents of said student to comport with academic criteria including said course offerings, course credits, and credit criteria required for graduation and academic criteria for admission to selected postsecondary educational institutions including required and preferred secondary course work of selected postsecondary educational institution(s);
2) storing amended course work selections from said student or parent(s) of said student in said repository database;
3) comparing said amended course work selection to said academic criteria including said course offerings, course credits, and credit criteria required for graduation and academic criteria for admission to selected postsecondary educational institution(s) including required and preferred secondary course work;
4) determining whether amended course work selection meets said academic criteria including said course offerings, course credits, and credit criteria required for graduation and academic criteria for admission to selected postsecondary educational institution(s) including required and preferred secondary course work;
5) notifying said student or parents of said student whether amended course work selection meets said academic criteria including said course offerings, course credits, and credit criteria required for graduation and academic criteria for admission to selected postsecondary educational institution(s) including required and preferred secondary course work.

14. The method of claim 13 further comprising the steps of:
1) submitting said course work selections from said student or parents of said student to an educator associated with said secondary educational institution for review and assessment;
2) receiving the review and assessment results from said educator associated with said secondary educational institution;
3) storing said review and assessment results from said educator associated with said secondary educational institution in repository database;
4) notifying said student or parents of said student of said review and assessment results from said educator associated with said secondary educational institution.

15. A method of claim 14 further comprising the steps of:
1) exporting course work selection to said secondary education institution's scheduling system upon receiving favorable review and assessment results from said educator associated with said secondary educational institution.

16. A method of claim 2 further comprising the steps of:
1) prompting the educators associated with at least one postsecondary educational institution(s) to input academic criteria for admissions, including required and preferred secondary course work for each offered degree or field of study at said postsecondary educational institution(s);
2) receiving academic criteria for admissions input including required and preferred secondary course work for each offered degree or field of study from said educators associated with said postsecondary educational institution(s);
3) storing academic criteria for admissions input including required and preferred secondary course work for each offered degree or field of study from said educators associated with said postsecondary secondary educational institution(s) in said repository database;
4) prompting at least one student or parents of said student to select at least one postsecondary educational institution(s) and at least one degree or field of study;
5) retrieving said course work selection and said academic criteria for admissions input including required and preferred secondary course work corresponding to said selected postsecondary educational institution(s) and said selected degree(s) or field(s) of study from said repository database;
6) comparing said course work selection and said academic criteria for admission including required and preferred secondary course work corresponding to selected postsecondary educational institution(s) and the selected degree(s) or field(s) of study;
7) determining whether said course work selection meets said academic criteria for admission to selected postsecondary educational institution(s) and the selected degree(s) or field(s) of study including required and preferred secondary course work;

17. The method of claim 16 further comprising the steps of:
1) receiving amended course work selections from said student or parents of said student to compare with academic criteria including said course offerings, course credits, and credit criteria required for graduation and academic criteria for admission to selected postsecondary educational institution(s) and the selected degree(s) or field(s) of study, including required and preferred secondary course work;
2) storing amended course work selections from said student or parents of said student in said repository database;
3) comparing said amended course work selection to said academic criteria including said course offerings, course credits, and credit criteria required for graduation and academic criteria for admission to selected postsecondary educational institution(s) and said selected degree(s) or field(s) of study including required and preferred secondary course work;
4) determining whether said amended course work selection meets said academic criteria including said course offerings, course credits, and credit criteria required for graduation and academic criteria for admission to selected postsecondary educational institution(s) and said selected degree(s) or field(s) of study, including required and preferred secondary course work;
5) notifying said student or parents of said student whether amended course work selection meets said academic criteria including said course offerings, course credits, and credit criteria required for graduation and academic criteria for admission including required and preferred secondary course work corresponding to selected postsecondary educational institution(s) and the selected degree(s) or field(s) of study.

18. The method of claim 17 further comprising the steps of:
1) submitting said course work selections from said student or parents of said student to an educator associated with said secondary educational institution for review and assessment;
2) receiving the review and assessment results from said educator associated with said secondary educational institution;
3) storing said review and assessment results from said educator associated with said secondary educational institution in repository database;
4) notifying said student or parents of said student of said review and assessment results from said educator associated with said secondary educational institution.

19. The method of claim 18 further comprising the steps of:
1) exporting course work selection to said secondary education institution's scheduling system upon receiving favorable review and assessment results from said educator associated with said secondary educational institution.

20. An apparatus for assisting parents, students, and educators to efficiently and collaboratively create and track an academic plan for secondary students and postsecondary students through the use of a repository database, the apparatus comprising:
Firmware or a programmable computer, programmed with and capable of executing software or some combination thereof that is capable of accepting information regarding a student's academic progress, course selection, and graduation requirements of students' current educational institutions, and admissions requirements and preferences of the educational institutions said student aspires to matriculate;
An output device for transmitting communication prompts regarding information needed by students, parents of students, and faculty or staff of educational institutions to efficiently and collaboratively create and a student's academic plan;
An input device for receiving input communication from students, parents of students, and faculty or staff for educational institutions to efficiently and collaboratively create and a student's academic plan;
A repository database for storing the information provided by students, parents of students, and faculty or staff for educational institutions.
